(19) United States
(12) Patent Application Publication
(10) Pub. No.: US 2008/0005752 A1
(43) Pub. Date: Jan. 3, 2008

(54) Methods, systems, and computer program products for generating application processes by linking applications

(76) Inventor: Robert Paul Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/479,441

(22) Filed: Jun. 30, 2006

(51) Int. Cl. G06F 9/44

(52) U.S. Cl. 719/331

(57) ABSTRACT

Methods, systems, and computer program products for generating application processes by linking applications are provided. According to one method, identifiers for each of first and second applications may be received via a GUI. Further, output data for the first application may be determined from an application descriptor associated with the first application. Input data for the second application may be determined from an application descriptor associated with the second application. The output and input data may be displayed via the GUI. Input indicating linking of the output data for the first application to the input data for the second application may be received via the GUI. A loadable instance to invoke the first application to generate a value for the output data and to invoke the second application with the generated value as the input data may be created.

### TECHNICAL FIELD

The subject matter described herein relates to methods, systems, and computer program products for generating application processes. More particularly, the subject matter described herein relates to methods, systems, and computer program products for generating application processes by linking applications.

### BACKGROUND

Commercial application software packages are typically designed to operate independently. Although an output of one application may be used by another application, the applications may not be designed to operate together. For example, the output of one application may not automatically be input into another application.

The UNIX operating system provides a framework known as “pipes” for allowing applications to operate together. Similar frameworks have been developed on other operating systems. Command line pipes may be used by an operator for linking together a series of applications to perform complex operations in a single step from the command line or from a shell script. However, a typical operator of a computer system may not be comfortable linking applications together with pipes. For example, the typical operator may be unfamiliar with the inputs and outputs of each application and the command line syntax required for manually linking applications. As a result, command line pipes may not serve the general population of computer users.

Command line pipes allow the output of one application to be provided as input to another application. This functionality allows a sequence of applications to be invoked by one command line versus separately invoking the applications, recording the output, and providing the output as input to subsequently invoked applications. In order to participate in the sequence, an application must be capable of receiving its input via “stdin” and writing its output to “stdout”. Scripts have been created to run on various operating systems to use the pipes framework. However, as stated above, the pipes framework may be difficult to use for operators with basic computer skills.

Some computer tools have been developed for allowing users to program the interoperability of applications using a graphical interface. However, these tools do not include a simple framework for linking applications to one another. Further, many of these tools are language dependent and/or task specific, require advanced computer skills, and require knowledge of the compatibility of applications.

In view of the shortcomings of existing techniques for linking applications, there exists a need for improved methods, systems, and computer program products for generating application processes by linking applications.

### SUMMARY

According to one aspect, the subject matter described herein includes a method for generating application processes by linking applications. The method includes receiving identifiers for each of first and second applications via a graphical user interface (GUI). Further, the method includes determining output data for the first application from an application descriptor associated with the first application. The method may also include determining input data for the second application from an application descriptor associated with the second application. The output and input data may be displayed via the GUI. Input indicating linking of the output data for the first application to the input data for the second application may be received via the GUI. A loadable instance to invoke the first application to generate a value for the output data and to invoke the second application with the generated value as the input data may be created.

The subject matter described herein can be implemented as a computer program product comprising computer executable instructions embodied in a computer readable medium. Exemplary computer readable media suitable for implementing the subject matter described herein include disk memory devices, chip memory devices, application specific integrated circuits, programmable logic devices, and downloadable electrical signals. In addition, a computer program product that implements the subject matter described herein may be located on a single device or computing platform. Alternatively, the subject matter described herein can be implemented on a computer program product that is distributed across multiple devices or computing platforms.

### BRIEF DESCRIPTION OF THE DRAWINGS

Exemplary embodiments of the subject matter will now be explained with reference to the accompanying drawings, of which:

FIG. 1 is a block diagram of an exemplary computer system for generating application processes by linking applications according to an embodiment of the subject matter described herein;

FIG. 2A is a flow chart of an exemplary process for generating application processes by linking applications according to an embodiment of the subject matter described herein;

FIG. 2B is a flow chart of an exemplary process for generating application processes by linking applications according to an embodiment of the subject matter described herein;

FIG. 3 is a block diagram of a linked application graph (LAG) instance record and application executables that are linked together by a LAG record according to an embodiment of the subject matter described herein;

FIG. 4 is an exemplary screen display of a GUI for interaction with an operator for generating a LAG according to an embodiment of the subject matter described herein;

FIG. 5 is an exemplary screen display of a GUI for interaction with an operator for generating a LAG according to an embodiment of the subject matter described herein;

FIG. 6 is an exemplary screen display of a GUI for operator interaction for editing a node in a chain of linked applications of a LAG according to an embodiment of the subject matter described herein;

FIG. 7 is an exemplary screen display of a GUI for selecting a next node in a chain of linked applications of a LAG according to an embodiment of the subject matter described herein;

FIGS. 8A and 8B are a flow chart of an exemplary process for generating a LAG according to an embodiment of the subject matter described herein;

FIG. 9 is a flow chart of an exemplary process for generating and processing an active LAG instance according to an embodiment of the subject matter described herein;

FIG. 10 is a block diagram of exemplary nodes of a LAG graph and their relationships according to an embodiment of the subject matter described herein;

FIG. 11 is an exemplary entity-relationship diagram of database tables capable of supporting a database environment according to an embodiment of the subject matter described herein; and

FIG. 12 is a block diagram of an import/export package according to an embodiment of the subject matter described herein.

### DETAILED DESCRIPTION

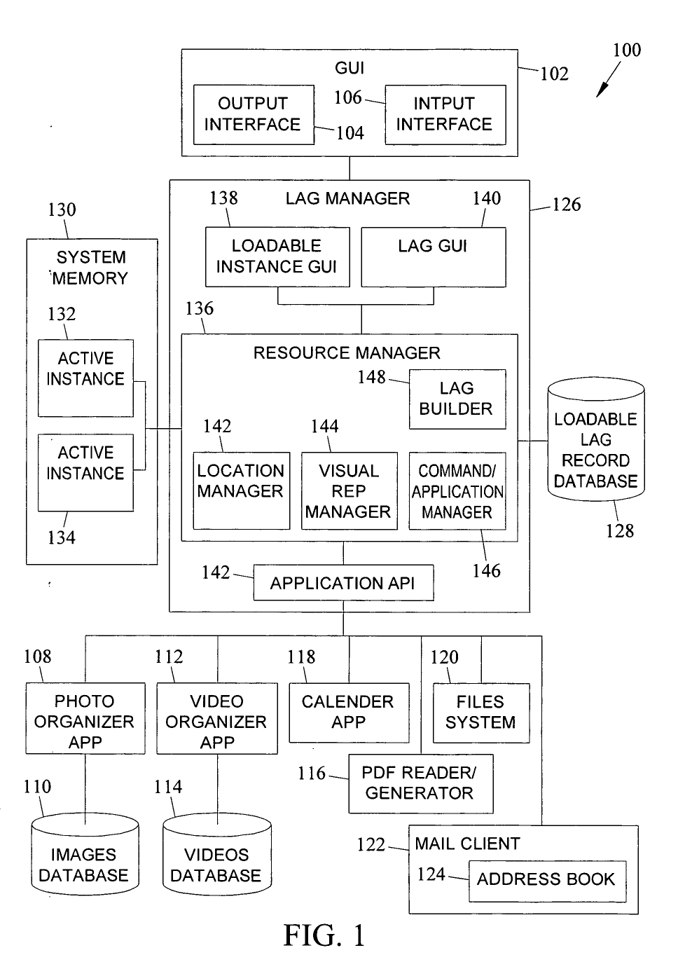

According to one aspect, a system for generating application processes by linking applications may be implemented as hardware, software, and/or firmware components executing on one or more components of a computer system. FIG. 1 illustrates a block diagram of an exemplary computer system 100 for generating application processes by linking applications according to an embodiment of the subject matter described herein. Computer system 100 may be any suitable system for invoking applications and for providing user interaction with the invoked applications. Further, system 100 may include a GUI 102 for receiving information from an operator and presenting information to an operator. GUI 102 may include an output interface 104 and an input interface 106. Output interface 104 may be operable to present information to a user in graphical format via any suitable output device, such as a display, a printer, a speaker, or any other suitable device with which information and graphics associated with one or more applications may be presented or shown. Input interface 106 may be operable to receive input from a user via any suitable device by which a user inputs information. For example, input interface 106 may be operable to receive user input via a keyboard, a keypad, a touch screen display, a mouse, a trackpad, or the like.

System 100 may include one or more executable applications. For example, applications resident on system 100 may include a photograph organizer 108 with associated database 110, a video organizer 112 with associated database 114, a PDF file reader and generator 116, a calendar application 118, a secondary files system 120, and a mail client 122 including an address book 124. System 100 may execute one or more of the applications, present information associated with the applications on output interface 104, and provide for user interaction with the applications. Further, system 100 may be operable to access remotely located applications, execute the applications, and provide for user interaction with the applications.

System 100 may include a linked application graph (LAG) manager 126 operable to generate application processes by linking input and output data of applications. As used herein, a linked application graph or LAG refers to an invokable instance of a plurality of applications whose execution is linked and that is capable of being visually represented. For example, input data and output data of applications 108, 112, 116, 118, 120, and 122 may be linked to one another for generating a LAG. A user may enter input into GUI 102 for controlling LAG manager 126 to link applications. Further, GUI 102 may display graphical information regarding the linking of applications.

An operator may use system 100 to construct a LAG by identifying one or more output values of a first set of applications, one or more input values of a second set of applications, and linking the output values of the first set of applications with the second set of applications. The operator may also provide user-specified input values for input to applications in the LAG. The user-specified input values may supplement output provided by applications in the LAG. System 100 may include means for receiving, via a GUI, identifiers for a first and second set of applications. For example, an operator may enter identifiers for a first and second set of applications via GUI 102.

Conditional branches and loops may be supported by LAG manager 126 to conditionally chain applications based on conditions, such as the type of output generated by an application. For example, LAG manager 126 may allow a user to specify that a text editor will be automatically opened after a first program executes if the output is a text file or that an image editor will be automatically opened if the output of the first program is an image file.

In one embodiment, a user may load a LAG by selecting a graphical representation of the LAG, such as an icon. Further, the user may initiate the LAG by providing an initial set of input values. A LAG instance may be a system resource that is accessible outside of LAG manager 126. LAGs may be considered “applications” which may be linked to other LAGs for allowing LAGs to build upon one another. Thus, LAG manager 126 may provide for linking chains of LAGs.

Applications may receive input and output values by a variety of suitable methods. For example, an application may receive input values via a command line style interface (e.g., args and argv [symbol] in the C computer programming language), reading information from a data stream such as “stdin”, and reading data from files identified via input or files known to the application. Further, for example, an application may deliver output values by writing to a data stream such as “stdout”, by writing to files identified via input or files known to the application, and by writing to a database. In another example, input and output values may be passed directly via calls using data (e.g., function, subroutine, and method).

In one embodiment, input and output data of applications may be linked by using information in an application descriptor identifying the applications' input and output data and invocation information for identifying a language neutral invocation means known to system 100. The application descriptor may be included as part of the respective application or may be a separate file, a database record, metadata about the application, and/or any of several known ways for storing information about an application. Examples of such techniques include command line invocation and message-based invocation means such as interrupts, signals, message queues, and subscription-based processes. Thus, knowledge of the language of the application or its language-specific call bindings may not be required.

According to one embodiment, input data may be stored persistently in system 100 for use during instantiation of a LAG. For example, an operator may define and persistently store data that is used as input for an application identified in a LAG. This persistently stored input data is referred to herein as a persistent data instance. In one example, a LAG or LAG instance with one or more associated, persistent data instances may result in a LAG that executes each time using the same input variables. That is, the persistent data instance associated with the LAG may store a set of input variables for applications in the LAG that does not change with each execution of the LAG. In another example, the LAG may execute each time producing output that it uses as input on the next activation. In such an example, the persistent data instance associated with the LAG may store output from the LAG that is used as input to subsequent executions of the LAG and that is overwritten with successive executions of the LAG. In another example, the LAG may execute each time storing its output to the same data instances regardless of the data instances it uses as input. In such an example, the persistent data instance associated with the LAG may store output from the LAG that is not used as input to successive executions of the LAG. In another example, the LAG may execute using as input the output of one or more applications that are not part of the LAG.

As described above, data from instantiation of a LAG may survive termination of the LAG. The surviving data may be stored persistently by system 100 for use in another LAG or another instantiation of the LAG. In one example, the value of the data may change on subsequent instantiations of the LAG.

According to one embodiment, an operator may be prompted for input during an instance of a LAG when input data is unavailable. For example, if required input data for an application is unavailable, the operator may be prompted via GUI 102 to enter a value for the input data. Further, the entered value may be optionally saved to an input set for the application so that the operator will not be prompted during another instance of the LAG. The operator may save the LAG with a new name for creating a new LAG using the entered value as input, thus preserving the original LAG which may serve as a template for creating new LAG instances.

An input set may be a set of persistent data instances or application outputs that are available for use as input to an application or applications in a LAG. Further, an input set may be an output set from the perspective of one or more applications that produce values for the set.

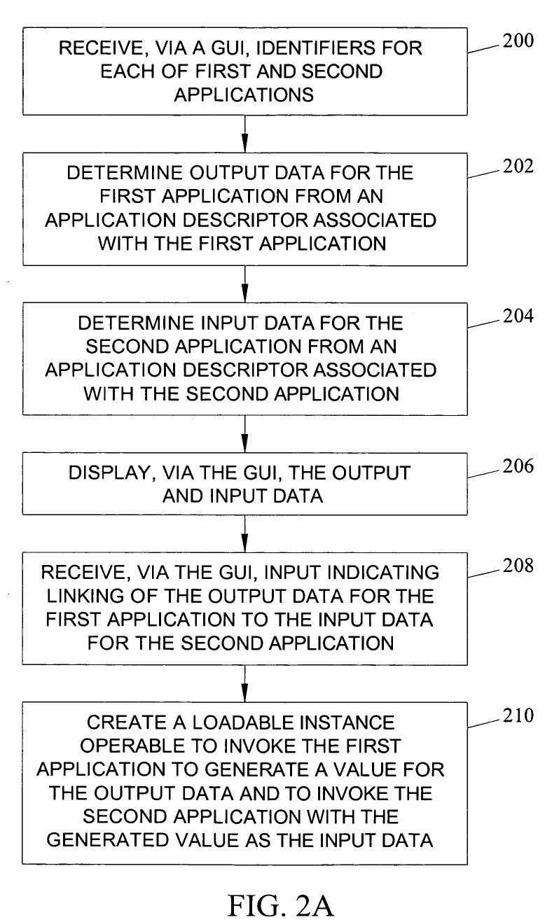

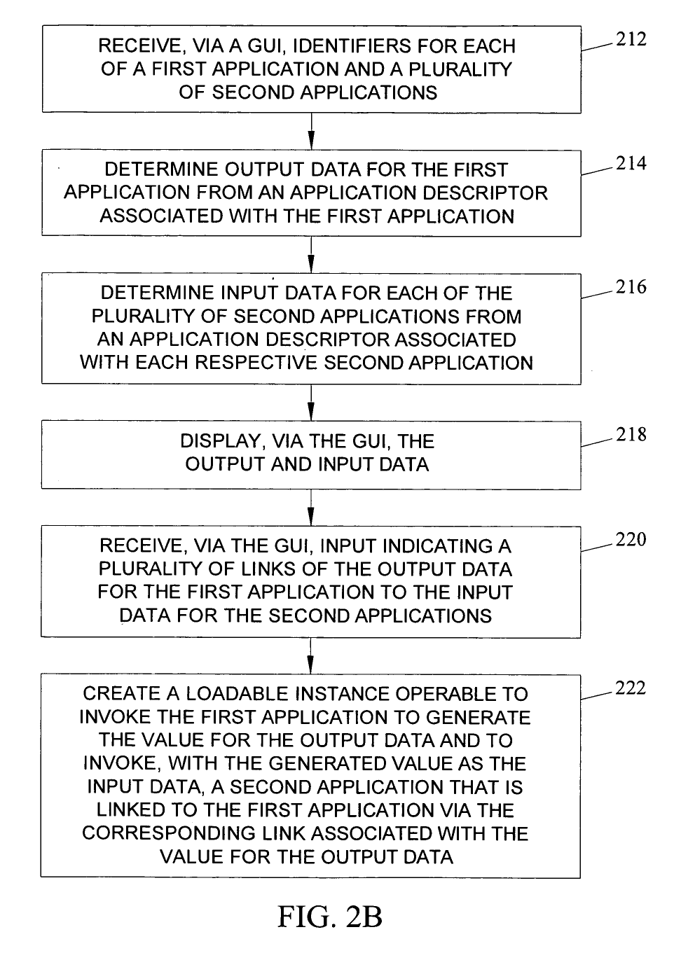

FIG. 2A is a flow chart illustrating an exemplary process for generating application processes by linking applications according to an embodiment of the subject matter described herein. Referring to FIG. 2A, at block 200, identifiers may be received via a GUI for each of first and second applications. Output data for the first application may be determined from an application descriptor associated with the first application (block 202). Input data for the second application may be determined from an application descriptor associated with the second application (block 204). The output and input data may be displayed via the GUI (block 206). At block 208, input indicating linking of the output data for the first application to the input data for the second application may be received via the GUI. At block 210, a loadable instance may be created that is operable to invoke the first application to generate a value for the output data and to invoke the second application with the generated value as the input data.

FIG. 2B is a flow chart illustrating an exemplary process for generating application processes by linking applications according to an embodiment of the subject matter described herein. Referring to FIG. 2B, at block 212, identifiers may be received via a GUI for each of a first application and a plurality of second applications. Output data for the first application may be determined from an application descriptor associated with the first application (block 214). Input data for each of the second applications may be determined from an application descriptor associated with each respective second application (block 216). The output and input data may be displayed via the GUI (block 218). At block 220, input indicating a plurality of links of the output data for the first application to the input data for the second applications may be received via the GUI. Each link may be associated with a different value for the output data for the first application. At block 222, a loadable instance may be created that is operable to invoke the first application to generate the value for the output and to invoke, with the generated value as the input data, a second application that is linked to the first application via the corresponding link associated with the value for the output data.

Input and output data information may be provided in an application descriptor. Further, each application descriptor may provide information describing at least one language independent means provided by the operating system of system 100 for invoking the associated application. Examples of invocation means include command line input and a system “exec( )” system call equivalent, the use of stdin, system message queues, and interrupts and signals. In some embodiments, application invocation may be supported by language specific invocation means and language neutral means. An application descriptor may include a command line template which LAG manager 126 may retrieve by invoking the associated application via a command line and providing an option such as /h, -h, /help, I?, or -help. Alternatively, an application descriptor may include XML or text files providing information regarding input and output data and invocation means. In one example, the association between an application and an application descriptor may be indicated by a naming convention, the relative locations of the files, by registration of the application with LAG manager 126 that supports a registration process or the associated application.

The following text is exemplary output received when an -h or /? option is provided at a command line.

```
Usage: awk [options] input=” ‘PROGRAM’ FILE ... | stdin”
output=”stdoout”
Input Options:
‘--field-separator=FS’
    USE FS for the input field separator (the value of the ‘FS’ predefined
    variable).
‘--file=PROGRAM-FILE’
    Read the ‘awk’ program source from the file PROGRAM-FILE,
    instead of from the first commands line argument.
‘--assign=VAR=VAL’
    Assign the variable VAR the value VAL before program execution
    begins.
‘--compat’
    Specifies compatibility mode, in which ‘awk’ extensions are turned
    off.
‘--posix’
    Specifies POSIX compatibility mode, in which ‘awk’ extensions are
    turned off and additional restrictions apply.
‘--source=PROGRAM-TEXT’
    Use PROGRAM-TEXT as ‘awk’ program source code.  This option
    allows mixing command line source code with source code from files,
    and is particularly useful for mixing command line programs with
    library functions.
Output Options:
‘--copyleft’
‘--copyright’
    Print the short version of the General Public License on the stderr
    output. This option may disappear in a future version of ‘awk’.
‘--help’
‘--usage’
    Print a relatively short summary of the available options on the stderr
    output.
‘--lint’
    Give warnings about dubious or non-portable ‘awk’ constructs.
‘--version’
    Print version information for this particular copy of ‘gawk’ on the
    stderr output. This option may disappear in a future
    version of ‘awk’.
```

The output includes command line syntax, options, and optional descriptions. The options are divided into output and non-output producing options. Use of the terms “stdin”, “stdout”, or “stderr” may be recognized as being associated with the option or input/output as an indication of a source or destination depending on the context. The LAG Manager parses this information to determine information about application input(s), output(s), and invocation.

The following is an exemplary partial application descriptor in XML format corresponding to the previous exemplary descriptor.

```
<application name=”awk” uuiid=”xxxx...”>
    <url runLocale=”local”>file::\\usr\awk</url>
    <invoke methods=”exec | cmd” usage=”awk [options] input” />
    <options>
        <input>
            <name>filed-separator</name?
            <type>string</type>
            <description>Use FS for the input field separator (the
                value of the ‘FS’ predefined variable).
            </description>
            <source syntax=”POSIX”>command line</source>
        </input>
        ...
        <output>
            <name alias=”usage”>help</name>
            <type>string</type>
            <description>Print the short version of the General
                Public License on the stderr output. This option
                may disappear in a future version of ‘awk’.
                </description>
            <source syntax=”POSIX”>command line</source>
        </output>
    </options>
    <input>
        <name>source file</name>
        <type>filename</type>
        <count>multiple</count>
        <description>Input file(s)</description>
        <source syntax=”plain” prefix”’PROGRAM FILE’ “>command
            line</source>
        <source>stdin(content)</source>
    </input>
    <output>
        <type>text</type>
        <destination>stdout</destination>
    </output>
</application>
```

System 100 may include means for determining output data for applications from application descriptors associated with the applications. For example, LAG manager 126 may determine output data for applications from application descriptors associated with the applications. Further, system 100 may include means for determining input data for applications from application descriptors associated with the applications. For example, LAG manager 126 may determine input data for applications from application descriptors associated with the applications.

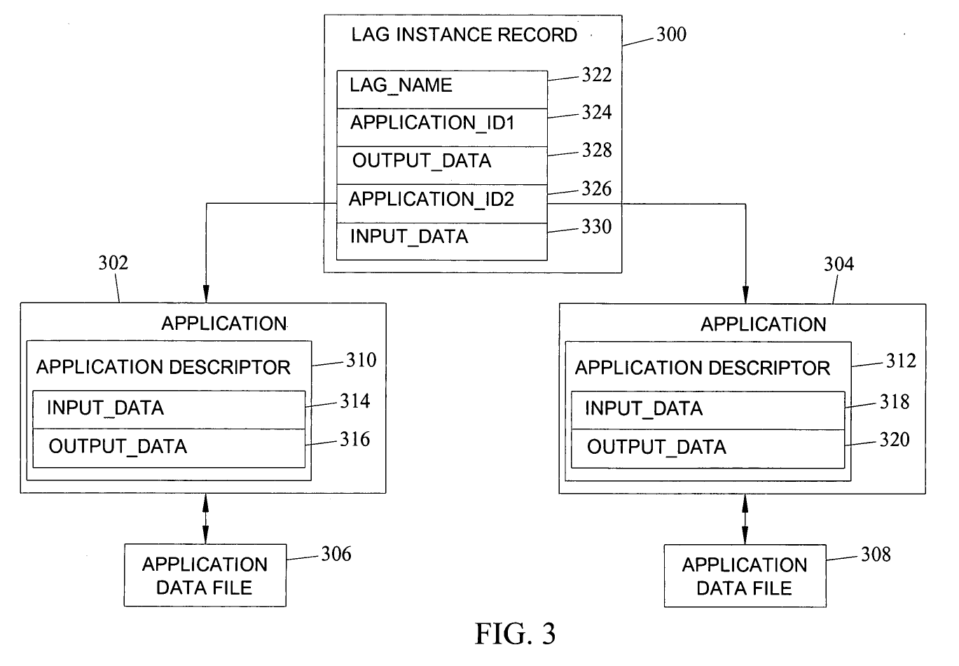

LAG manager 126 may maintain a plurality of LAG instance records, each of which may be created by a user through the LAG Manager 126 for linking applications and maintained independent of any executable of applications in system 100. FIG. 3 is a block diagram of a LAG instance record 300 and application executables 302 and 304 that are linked together by LAG record 300 according to an embodiment of the subject matter described herein. A user may interact with GUI 102 of system 100 for creating LAG instance record 300 for linking application executables 302 and 304. LAG instance record 300 and application executables 302 and 304 may be managed by system 100. Logical associations may be defined among these resources using any suitable means to system 100. For example, application data files 306 and 308 may be associated with application executables 302 and 304, respectively, through respective file name extensions and/or through associated tables maintained in system 100.

Application executables 302 and 304 may include application descriptors 310 and 312, respectively. Application descriptor 310 may include a plurality of data fields including an input data field 314 and an output data field 316 whose contents may configure attributes of application 302. For example, application executable 302 may be a photo organizer application for organizing and editing digital photos. Input data 314 may be a request for editing a photo. Output data 316 may be a request for a file name of a photo for editing with the photo organizer application.

Application descriptor 312 may include a plurality of data fields including an input data field 318 and an output data field 320 whose contents may configure attributes of application 302. For example, application executable may be a find files application for searching for files. An output data of a find files application may be identification and location information for particular types of files.

LAG instance record 300 may include a plurality of information fields including a LAG record name field 322, application identifier fields 324 and 326, application output data 328, and application input data 330. Record name field 322 may identify the record. For example, the contents of field 322 may be in the form of an ASCII character string. Application identifier fields 324 and 326 may identify applications 302 and 304, respectively. For example, fields 324 and 326 may be populated with a pointer, URL, file directory path, direct executable invocation command, or other suitable application indicator. Output data 328 may correspond to output data 316 of application 302. Input data 330 may correspond to input data 318 of application 304. Record 300 may be used for linking output data 316 of application 302 to input data 318 of application 304 according to the subject matter described herein. In one example, a file name request output data of a find file application may be linked to an input data of a photo organizer application. When the LAG is instantiated, the find file application is executed to find a particular file producing as output a path to the file and the photo organizer application may then be instantiated providing the path to the file as input.

The number of input and output data fields included in record 300 may be defined during the creation of record 300 or added at a later time by an operator. The input and output data fields included in record 300 may be displayed or otherwise presented to an operator via GUI 102. GUI 102 and LAG manager 126 may be used by an operator for linking applications by associating the output data instances of one or more applications with the input sets of one or more applications.

Returning to FIG. 1, system 100 may include a loadable instance and LAG record database 128. Database 128 may provide storage for one or more LAG instance records. For example, database 128 may store LAG instance record 300 in any suitable format.

System 100 may include a main system memory resource 130. Resource 130 may include space allocated to one or more active instances. For example, resource 130 may store active instances 132 and 134. Instances 132 and 134 may be copies of applications 302 and 304, respectively, linked together via LAG instance record 300. Applications 302 and 304 may be instantiated with instance values from record 300. Further, an output value of application 302 may be used as the input value for application 304 in accordance with the subject matter described herein.

LAG manager 126 may include a resource manager 136, a loadable instance GUI 138, a LAG GUI 140, and an application programming interface (API) resource 142. Resource manager 136 may manage a plurality of LAG instance records stored in database 128, a plurality of LAG graphics, and a plurality of executables. Resource manager 136 may interact with system 100 in order to obtain definitions for all of the logical associations among a record, a referenced application executable, and one or more data files associated with the application executable. Further, resource manager 136 may include a database management resource to control the contents, organization, and format of database 128.

Resource manager 132 may include a location manager 142, a visual representation manager 144, a command/application manager 146, and a LAG builder 148. Location manager 142 may provide access to system resources and/or applications outside of LAG manager 126 that may be referenced in a LAG instance record. For example, location manager 142 may include a list of pointers to display icon definition files, host system registries for one or more application executables, and/or file structures for system 100. Visual representation manager 144 may provide resources to retrieve one or more display icon image files, directories, windows, and/or similar graphical display information. Further, visual representation manager 144 may organize the available display resources to be displayed on output interface 104. Command/application manager 146 may provide access to one or more application executables resident in system 100. References to application executables may either be directly stored in resource manager 136 or may be maintained through location manager 142. Command/application manager 146 may also include functionality to permit resource manager 136 to interrogate an application executable to request a list of application descriptor input and/or output data.

LAG builder 148 may operate to build and manage LAG instance records and LAG instances. Further, LAG builder 148 may operate with command/application manager 146 to locate and process applications and associated application descriptors. LAG builder 148 may operate with visual representation manager 144 and location manager 146 in generating LAG instances based on LAG records. LAG input/output data, LAG instance data, and active LAG instance data may be stored in database 128 under control of LAG builder 148.

Loadable instance GUI 134 and LAG GUI 136 may operate in conjunction with interface 102 to provide an interface with an operator to create and manage LAG records. Loadable instance GUI 134 may be operable to locate and activate applications and LAG instances. LAG GUI 136 may control interface 102 to display input and output data of applications to an operator. Further, LAG GUI 136 may control interface 102 to receive input from an operator regarding the linking of applications.

API 138 may be operable to permit one or more application executables to access one or more LAG instance records and/or other resources controlled by resource manager 136. For example, an executable may obtain a list of all records whose executable reference field identifies the executable, in order to display a list of available loadable instances on a GUI display, such as output interface 104.

A GUI may include one or more graphical images and/or data that appear on a display screen. An operator may interact with applications and LAG instances by using a GUI. Further, an operator may create a LAG record by interacting with a screen display of a GUI. LAG GUI 140 may be used by an operator for working with specific input and output data or set of data. LAG GUI 140 may display applications that may receive data as input or produce data as output based on user input. LAG manager 126 may use a set of input/output data to identify the applications and LAG instances that are compatible when the input/output data is assigned values and provided as input. An operator may create a group of input/output data associated with an application or a LAG instance for selection and provide instance input/output data to serve as initial values. In order to run an associated application or LAG instance, an operator may select the group of input/output data instances, select a compatible application or LAG instance, and indicate that the LAG manager 126 is to run the application or LAG instance using the input/output data instances as input. System 100 may include means for displaying output and input data. For example, GUI 102 may display output and input data of one or more applications.

According to one embodiment, an operator may use a GUI to specify that LAG manager 126 present applications that exactly match the selected input/output data. For example, if the user selects an image file as input data, LAG manager 126 may display a set of image editor applications as potential recipients of the image file as input. Alternatively, the operator may specify that LAG manager 126 present applications that are compatible with a subset of the selected data. For example, if the user selects an image file and a constant value as input data, LAG manager 126 may present as potential recipients applications that can receive the image file or the constant value as input data. Filtering applications to be presented to a user as potential links in a LAG chain based on input data facilitates creation of LAG chains because the user can select among compatible applications rather than all applications that are present on a system.

In one embodiment, an operator may use a GUI to specify that LAG manager 126 present applications that are compatible with the selected data as a portion of the operation requirements for each displayed application. LAG GUI 140 may identify data that is required when a user selects an application.

System 100 may include means for receiving, via a GUI, input indicating linking of one or more output data for one or more applications to one or more input data for one or more other applications. For example, GUI 102 may provide an interface for receiving input instructions for linking output data of an application to input data for a plurality of other applications. System may also include a means for creating a loadable instance operable to invoke an application to generate a value for output data and to invoke a second application with the generated value as the input data. For example, LAG manager 126 may create a loadable instance operable to invoke an application to generate a value for output data and to invoke a second application with the generated value as the input data.

In one embodiment, each link between a first application and a plurality of second applications may be associated with a different value for the output data for the first application. System 100 may include means for creating a loadable instance operable to invoke the first application to generate the value for the output data and to invoke, with the generated value as the input data, a second application that is linked to the first application via the corresponding link associated with the value for the output data. For example, LAG manager 126 may create a loadable instance for invoking the first application to generate the value for the output data. Further, the loadable instance may invoke, with the generated value as the input data, a second application that is linked to the first application via the corresponding link associated with the value for the output data.

An operator may use a GUI to specify input data or a set of input data to be used in a LAG. For example, LAG GUI 140 may identify applications and LAG instances that produce an instance of the data or set of instances for the input set of data as a result or output. When the operator selects an application or a LAG instance associated with output data or set output of data, LAG manager 126 may provide a GUI for the user to select existing instances or data instance sets prior to starting execution of the selected application or LAG instance.

An operator may also use a GUI to specify output data of a set of output data. For example, LAG GUI 140 may identify applications and LAG instances that produce an output matching a group of selected output data. When the operator selects an application or a LAG instance associated with selected output data or set of output data, LAG GUI 140 may display applications that produce data for the group of selected output data. Alternatively, LAG GUI 140 may display applications that generate data for at least one of the selected output data.

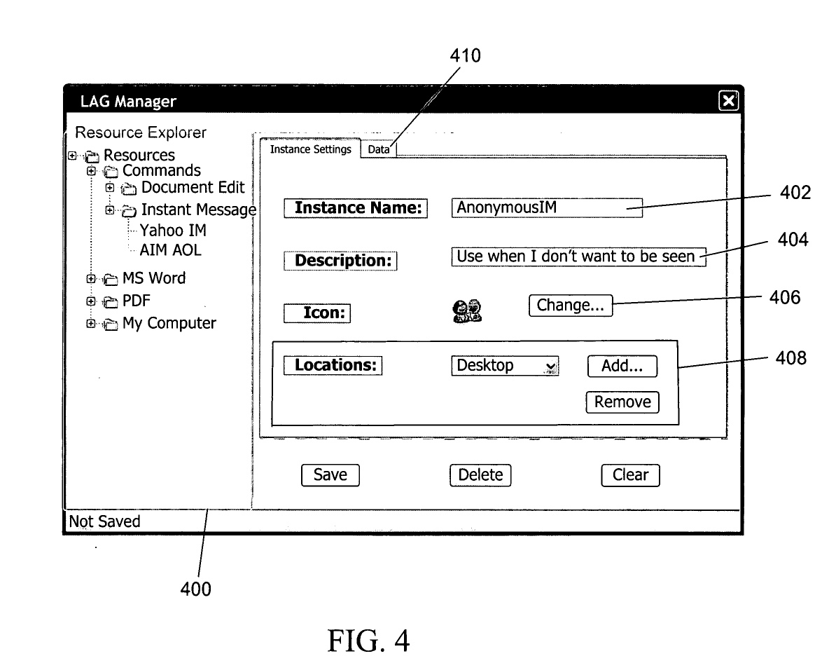

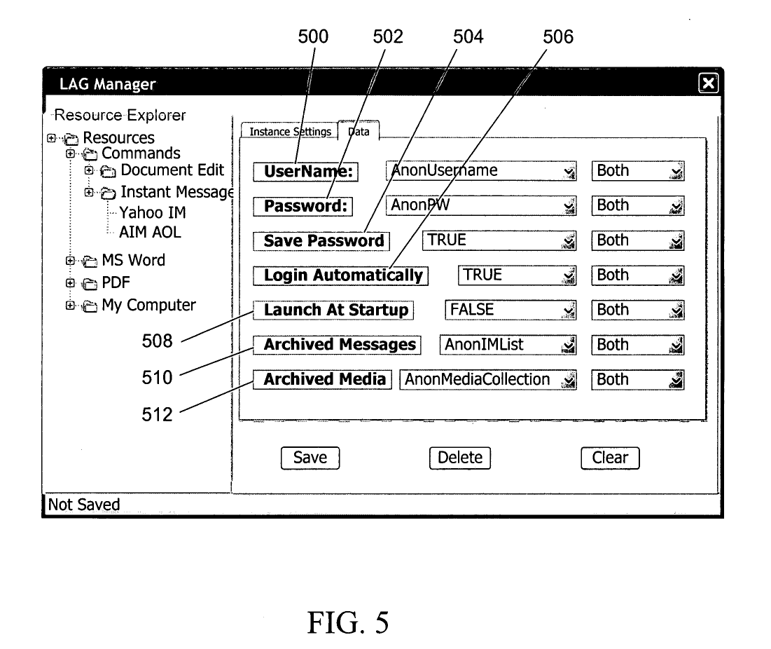

FIGS. 4 and 5 are exemplary screen displays of a GUI for interaction with an operator for generating a LAG according to an embodiment of the subject matter described herein. Referring to FIG. 4, an operator may use a mouse for selecting an application that is to be the first application in a chain of two or more applications. The operator may select an application from a resource explorer box 400. For example, the operator may use a mouse to control a cursor for selecting the Yahoo Instant Messaging (IM) application (available from Yahoo! Inc. of Sunnyvale, Calif.). The operator may specify an input set instance for the LAG. Further, the operator may enter an instance name in dialog box 402 and a description in dialog box 404. The operator may specify a graphical icon for representing the LAG via box 406. The graphical icon may be created when a loadable instance of the LAG is created. Further, the operator may specify a location for the graphical icon in box 408. The graphical icon may be selected at the specified location for instantiating the LAG. For example, the graphical icon may be selected on a desktop of a display of output interface 104 for instantiating the LAG. The operator may enter additional information by selecting data tab 410.

FIG. 5 is an exemplary screen display that may be shown on the GUI when data tab 410 is selected. An operator may interact with this display in order to configure LAG instantiation. For example, an operator may enter a user name and a password at boxes 500 and 502, respectively. The operator may optionally save a password at box 504. The operator may also set the LAG to login automatically at box 506. Further, the operator may select to launch the LAG at startup at box 508. The operator may also selectively archive messages and media at boxes 510 and 512, respectively.

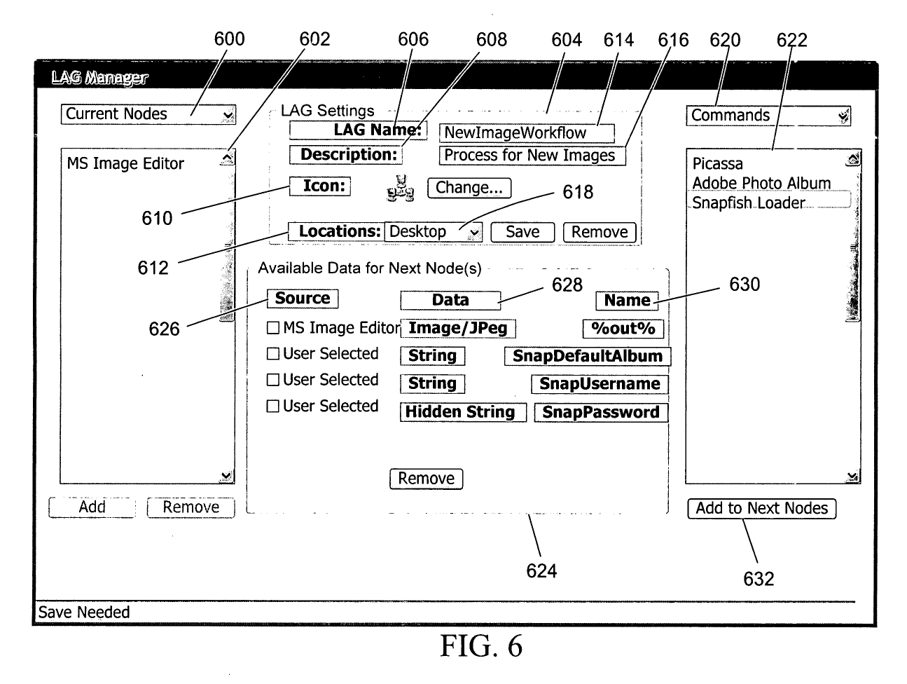

FIG. 6 is an exemplary screen display of a GUI for operator interaction for editing a node in a chain of linked applications of a LAG according to an embodiment of the subject matter described herein. Referring to FIG. 6, the node may be a first node or an intermediate node in a LAG chain. A drop down menu 600 shows that the currently displayed node is an “MS Image Editor” application, as shown in box 602. The application is an image editor application. Further, a LAG settings box 604 indicates the currently displayed LAG name at box 606, a description for the LAG at box 608, an icon for the LAG at box 610, and the location for the display of the icon at box 612. An operator may enter a name for the LAG at a text entry box 614, enter a description for the LAG at text entry box 616, and select one or more locations for a graphical representation of the LAG may be shown at a drop down menu 618. The graphical representation may be location specific.

According to one embodiment, system 100 may identify applications that produce output that are compatible input data for selected applications. For example, LAG manager 126 may determine output data of an application that are compatible input data for another application. Linking of the output data of the application to input data of the other application may be controlled based on the compatibility determination. For example, referring to FIG. 6, an output of the image application may be an image file of a JPEG type. LAG manager 126 may determine other applications that are accessible by system 100 and that include input data that is compatible with the image file output of the image application. When the MS Image Editor application is selected, LAG manager 126 automatically determines applications having compatible input data for the output of the image application. A drop down box 620 may be used for selecting the “Commands” function, as shown in FIG. 6. Display box 622 may display compatible applications “Picassa”, “Adobe Photo Album”, and “Snapfish Loader”.

A list of applications that generate a compatible output may be displayed by selecting “Commands” from menu 620. An operator may select one or more of the applications displayed in box 622 for linking to the current application. In the example shown in FIG. 6, the “Snapfish Loader” application may be selected. Box 624 may show the outputs of the current application with an indication the compatible applications in box 622. Further, the operator may select an input source and input data for the selected applications by using a display box 624. When an input source is selected, box 624 may show the input data required by the selected application. Box 624 may include a source list under source indicia 626 including sources of input values for the selected application. The default output of the MS Editor Image application is compatible with the images that the Snapfish Loader application may receive as input. Box 624 may include an input data list under data indicia 628 including input data types. The default output may be output written to “stdout” and denoted by “% out %”. Indicia 628 shows user selected data for which there is no current input but indicating that the input is user selectable. If a user selectable check is selected, an operator may be provided an option to enter value to be used as input at configuration, prompt for it at runtime, or allow the user to select “Current command data” from drop down menu 600. A list of compatible persistent input/output data may be shown by selecting “Persistent Data” from menu 620. When the link has been configured, an “Add to Next Nodes” icon 632 may be selected for adding the link.

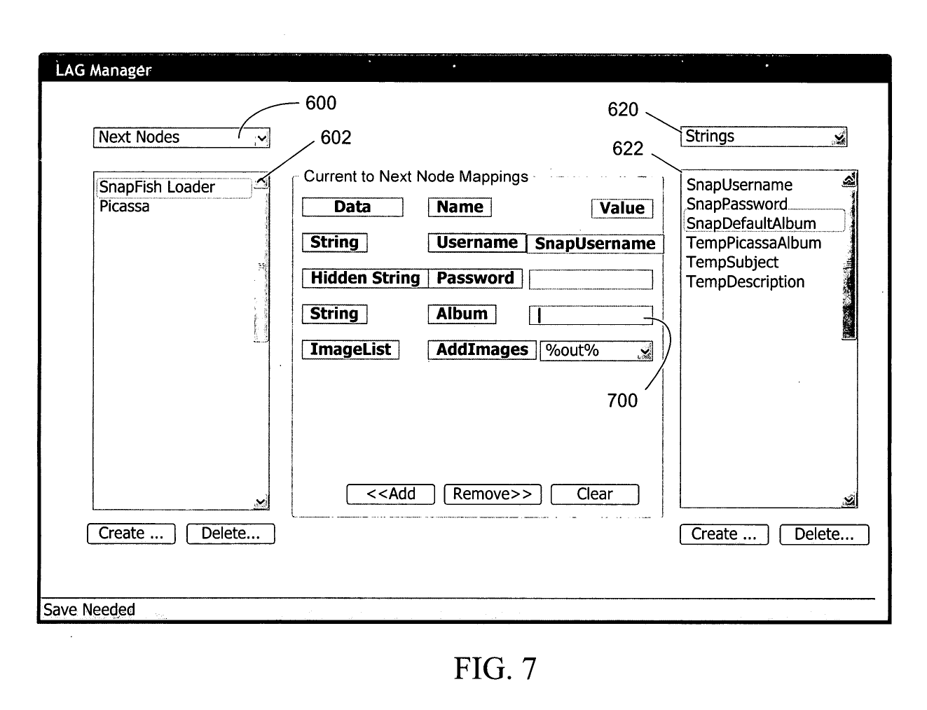

FIG. 7 is an exemplary screen display of a GUI for selecting a next node in a chain of linked applications of a LAG according to an embodiment of the subject matter described herein. Referring to FIG. 7, a next node selection mode for the GUI may be selected using drop down menu 600. An application for the next node may be selected in box 602. In this example, the “Snapfish Loader” application is selected. When an application is selected, GUI manager 126 may determine input data for the selected application. Box 622 shows input data for the selected application. An operator may select “Persistent Data” by type. In this example, a cursor is positioned in the “Album” input data box 700 for the “Snapfish Loader” application. When the cursor is positioned in box 700, box 622 shows a list of compatible data by type if the application descriptor for the “Snapfish Loader” application includes type information and the embodiment supports typed data.

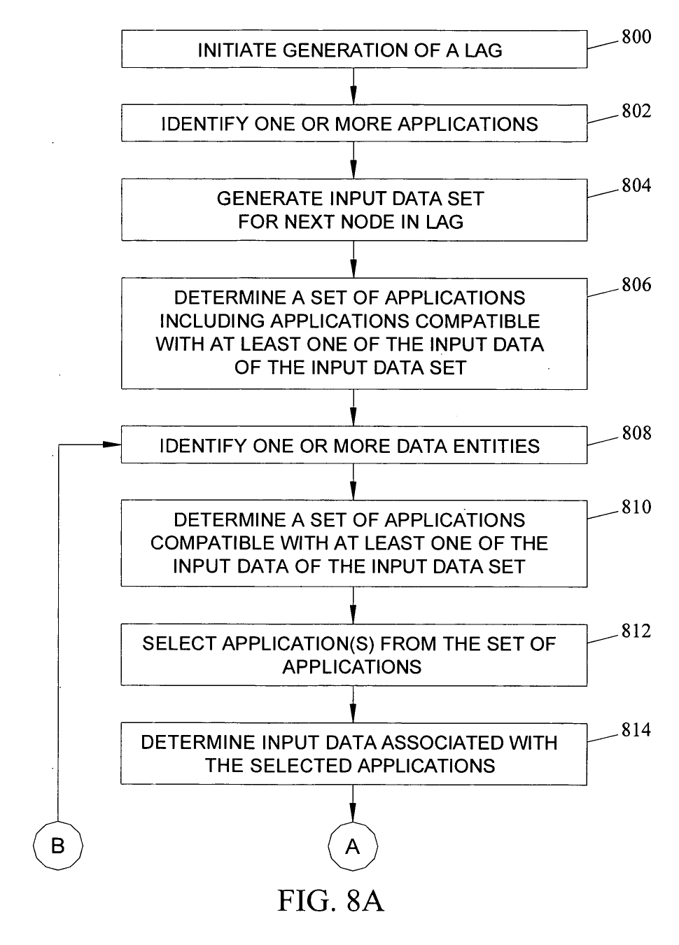

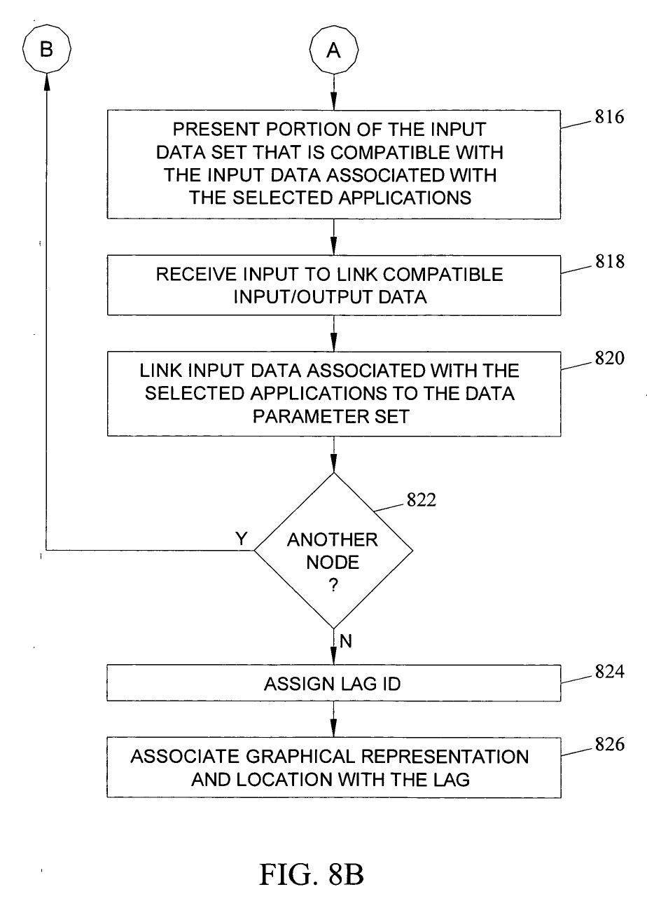

FIGS. 8A and 8B are a flow chart illustrating an exemplary process for generating a LAG according to an embodiment of the subject matter described herein. Referring to FIG. 8A, at block 800, an operator may initiate generation of a LAG via GUI 102. At block 802, the operator may identify one or more applications for the first node in a graph of the LAG. Next, at block 804, LAG manager 126 may determine a set of output data for the applications of the first node. The output data for the application may be determined based on application descriptors associated with the applications. Further, the operator may use GUI 102 for identifying one or more other data entities at block 806. LAG manager 126 may generate an input data set for the next node in the LAG graph based on the set of output data for the applications and the identified data entities (block 808).

At block 810, LAG manager 126 may determine a set of applications including applications that are compatible with at least one of the input data of the input data set. An application may be compatible with input data if the application may use the input data as input. The set of applications may be presented to the operator via GUI 102.

At block 812, the operator may use GUI 102 for selecting one or more applications from the set of applications presented to the user. LAG manager 126 may determine input data associated with the selected applications (block 814). Referring to block 816 of FIG. 8B, LAG manager 126 may control GUI 102 to present the portion of the input data set including output values of the first node that are compatible with the input data associated with the selected applications. The operator may use GUI 102 for linking compatible input/output data (block 818). LAG manager 126 may link the input data associated with the selected applications to the input data set (block 820). As a result, the data entities identified by the operator at block 808 and selected output data of the applications of the first node may be linked.

At block 822, LAG manager 126 may determine whether to add another node to the LAG. For example, the operator may provide input to GUI 102 for indicating that another node is to be added to the LAG. If it is determined that another node is not to be added to the LAG, a LAG ID may be assigned to the LAG (block 824). Further, a graphical representation and location to display the graphical representation may be generated for the LAG (block 826).

If it is determined that another node is to be added to the LAG, the process may proceed to block 808 for adding another node to the LAG. The process may proceed through the blocks following block 808 for determining compatible applications for the next node and linking the applications of the next node to the previous node.

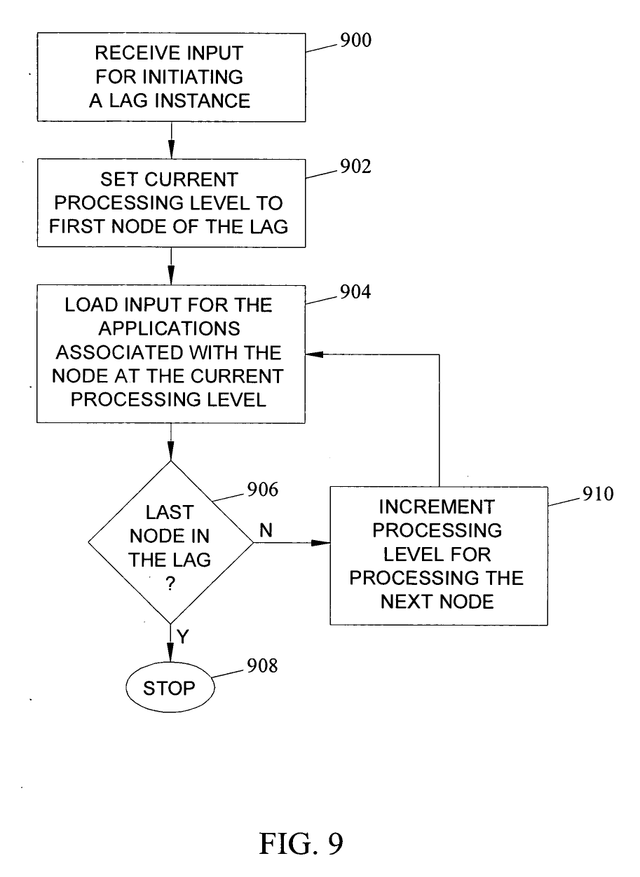

FIG. 9 is a flow chart illustrating an exemplary process for generating and processing an active LAG instance according to an embodiment of the subject matter described herein. Referring to FIG. 9, at block 900, LAG manager 126 may receive input for initiating a LAG instance. For example, an operator may select a graphical icon representing the LAG via GUI 102. In another example, the LAG instance may be initiated by operator input to an application of system 100. Further, for example, the LAG may be triggered by the output of an application running on system 100. At block 902, LAG manager 126 may set the current processing level for the LAG to the first node in the LAG.

At block 904, LAG manager 126 may load input for the applications associated with the node at the current processing level as indicated by the LAG. In one example, the input may be data stored persistently in system 100 for use during instantiation of the LAG. In another example, the input may be data output from an application. The data output may be output generated by an application in a previous node linked to an application in the current node if the current node is not the first node in the LAG.

At block 906, LAG manager 126 may determine whether the node at the current processing level is the last node in the LAG. If it is determined that the node at the current processing level is the last node in the LAG, the process may stop at block 908. Otherwise, if it is determined that the node at the current processing level is not the last node in the LAG, the process may increment the processing level for processing the next node in the LAG at block 910. The process may proceed to block 904 for processing the next node in the LAG and any other subsequent nodes until each node in the LAG is processed.

In one embodiment, the operator may select an application and add the application to current nodes. An operator may view application in a LAG graph by selecting menus for current nodes and next nodes. Next nodes may be selected to be current nodes in order to add nodes to the LAG graph. GUI 102 may display the input/output data mappings and identify unmapped input/output data. For input/output data that has not been mapped or user choices have been made, a default may be provided to prompt the operator for the input/output data value at runtime. The operator may run the LAG graph repeatedly, provide different inputs, and save the inputs as distinct LAG instances.

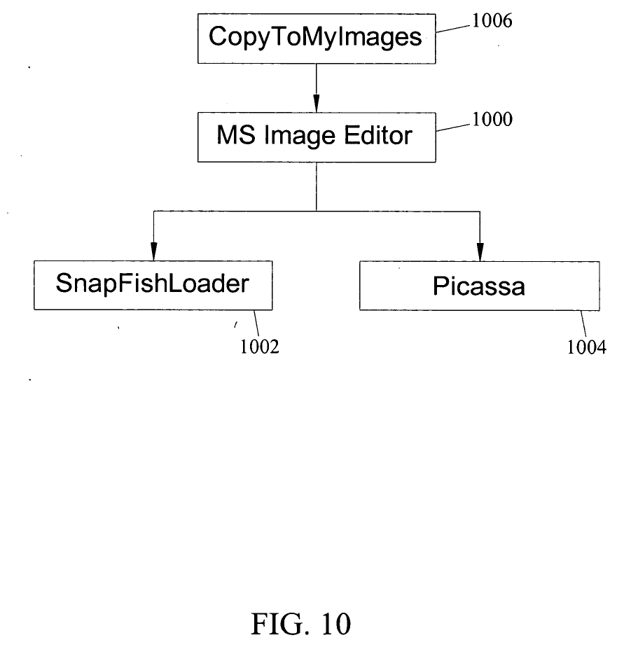

FIG. 10 is a block diagram of exemplary nodes of a LAG graph and their relationships according to an embodiment of the subject matter described herein. The LAG graph includes an image editor application 1000, a “SnapFishLoader” application 1002, and a “Picassa” application 1004. A loadable instance of a file copy command 1006 may initiate the LAG and provide an input value for image editor application 1000. Image editor application 1000 may generate one or more output values based on the received input value. In the example illustrated, image editor application. 1000 produces one output, a JPEG image. The output value from application 1000 may be input into “SnapFishLoader” application 1002, and also provided as input into “Picassa” application 1004. In other cases, one application may produce multiple outputs, some may be used as input in the next level of applications and other applications in the level may use others of the output values. An output from a level may be used as an input in a level beyond the next level, for example, two or three levels further into the application graph.

In one embodiment, the representation of the LAG graph shown in FIG. 10 may be presented to an operator via GUI 102. An operator may navigate the displayed LAG graph and select nodes and/or relationships to modify. Further, the display may show configured and unconfigured nodes/relationships using such indicia as icons, colors, and the like.

The methods and systems described herein for creating instances of linked applications may be implemented in database environment where execution, linking, and loading of system resources are managed using a database management system (DBMS). For example, a system in accordance with the subject matter described herein may be implemented in the database environment described in a commonly-assigned, co-pending U.S. patent application entitled “Methods, Systems, and Computer Program Products for Providing a Program Execution Environment”, filed on even date herewith, the disclosure of which is incorporated herein in its entirety.

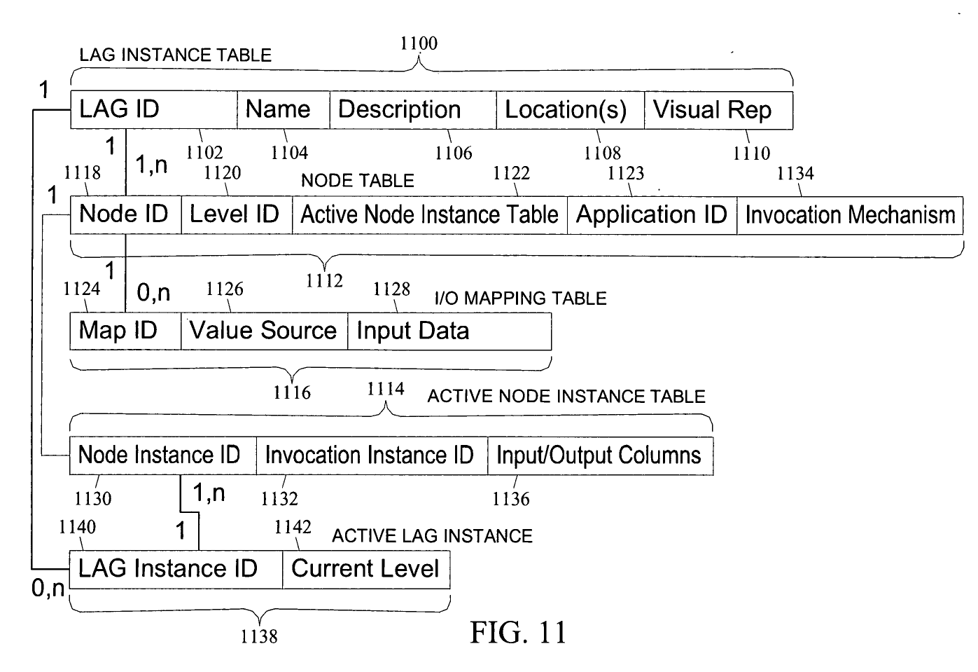

FIG. 11 illustrates an exemplary entity-relationship diagram of database tables capable of supporting relationships between executables and input/output data that form a LAG according to an embodiment of the subject matter described herein. A LAG instance table 1100 may include a LAG ID 1102, a LAG name 1104, a description 1106, one or more locations 1108, and one or more visual representations 1110. Table 1100 may reference applications at all levels of the LAG in a node table 1112 via a link table (not shown).

Node table 1112 may identify the level in a graph that a node operates and point to an active node instance table 1114 associated with the application. Active node instance table 1114 may provide a schema for an application's input and output and may be generated using an application's application descriptor. Node table 1112 may reference an I/O mapping table 1116. Node table 1112 may include a node ID 1118, a level ID 1120, an active node instance table 1122, an application ID 1123 to identify the application associated with the node, and one or more invocation mechanisms 1134. I/O mapping table 1116 may include a map ID 1124, a value source 1126, and input data 1128.

Active node instance table 1114 may include a node instance ID 1130, an invocation instance ID 1132, and input/output columns 1136. Each record of table 1114 corresponds to an active application in the graph. The input/output columns may contain data references pointing to records in I/O mapping table 1116 for passing output values to input values. Alternatively, values from I/O mapping table 116 records may be copied to input columns and values in output columns may be copied to records as output.

I/O mapping table 1116 may be associated with a node ID or a level ID which is associated with a LAG via a LAG ID. Multiple records may include the same map ID. A record may map a value indicating that the operator is to be prompted for a value of input data of a node. I/O mapping table map ID 1124 may identify an input set.

LAG ID 902 may point to an active LAG instance table 1138. Table 1138 may include a LAG instance ID 1140 and a current level 1142. Each active LAG may have a record in table 1138. Level 1142 may indicate the currently active level of the node in a graph.

According to one embodiment, a system GUI may be operable to export LAGs, input/output data, applications, and their instances from the system. Further, the system GUI may import LAGs, input data, output data, applications, and their instances into the system.

The following exemplary program code specification defines a package that may be either exported from a LAG manager, programmed by an operator, or using a tool for importing into a LAG manager. Other suitable specification grammars may be utilized. For example, if LAG manager 126 uses an SQL database, the import/export specification may include one or more SQL scripts.

```
<package>
    <Parameter type=”List”/>
    <Parameter type=”URL” />
    <Application id=”1”>
        <url runLocale=”local”>c:\myXUL\CompatibleFilesWindow.xul
</url>
        <data id=”1.1 input=”true” Parameter=”List” source=”stdin |
command | instance”>fileList</data>
    </Application>
    <Application id=”2”><url>system://FileSearch</url></data>
    <Application id=”3”>
        <url runLocale=”local”>c:\myPerl\StartAndPass</url>
        <data id=3.2” input=true Parameter=”any” source=”stdin |
command | instance” “/>
    </Application>
    <LAG>
        <ApplicationId>3</ApplicationId>
        <ApplicationId>2</ApplicationId>
        <ApplicationId>1</ApplicationId>
    </LAG>
</package>
```

In the above program code specification, the <package> element specifies the start of the specification. The <parameter> element may define data types required by the package. Only types that are not already in a LAG manager may be required. Thus, types provided with the LAG manager and found in widely distributed utility packages do not require specification. The “List” type and the “URL” type demonstrate exemplary syntax and may both be default data types provided by the LAG manager.

Further, in the above program code specification, applications are identified. Applications may include ID attributes to allow the applications to be used for specifying a loadable instance. The location of an application may be required. The application location may be specified by a URL. In one embodiment, a script may be provided in the <application> element. Sub-elements of the <application> element may specify input/output data and their roles as input or output data or both. A data entity may be input, output, or an instance in the LAG manager used for input or output as defined by its attributes. A data element may have more than one role. The process used to access a data element may also be specified using the “source” attribute. Further, the scope of a data element may be provided by specifying its “scope” attribute. Scope refers to the levels and/or nodes which may have access to the data element as input or output. Defaults exist for all data element attributes and application attributes.

An import/export program code specification may contain the specification for a LAG or a LAG instance which may be a list of applications that can be run as an active, loaded LAG instance. An application in a LAG instance may be identified by its ID in the specification or by its name in a LAG manager. A simple list of applications to be run in sequence may be specified as an in order list as in the above example. More complicated LAGs require that each <application> node be associated with a level specified either as an attribute of the <application> element or using a <level> element to enclose the application nodes in the level.

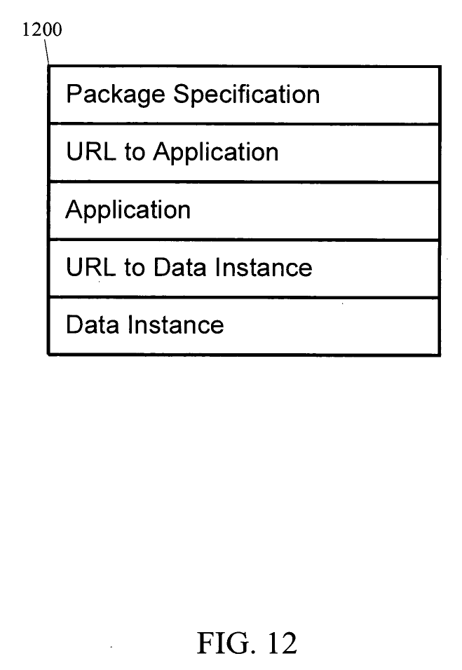

FIG. 12 is a block diagram of an import/export package 1200 according to an embodiment of the subject matter described herein. The package may include three applications that are run consecutively with input that is provided from one or more specified input sets. Mapping of output to input may be specified by using <data> IDs and a <map> element. The following exemplary XML specification defines mapping of output to input.

```
<LAG id=”10”>
    <InputSetId value=”0”/>
    <ApplicationID value=”1”>
        <map out=”0.2” in=”1.1” />
    </ApplicationID>
    <Application value=”2”>
        <map out=”1.2” in=”2.1”/>
        <map out=”0.1” in=”2.2”/>
    </Application>
</LAG>
```

The <InputSetId> element may identify an input set by ID that is associated with the LAG. The LAG starts with an application having an identifier of “1”. Data from the input set identified by “0.2” may be mapped to the input data identified by “1.1”. Mappings for the application with an ID of “2” are similar. Application “2” may receive input from the input set and from a previously run application. Level numbers may be specified for applications and input sets in a LAG identifying their order of execution and scope, respectively. If no level numbers are provided, applications may be run in the order that they appear and an input set is available to all applications identified after its element appears.

Applications and input/output data managed by a LAG manager may be associated with a name and a name space qualifier. For example, LAG manager 126 may use a name space qualifier or may require an operator to register a qualifier with a directory service to ensure its uniqueness. Names within a namespace may be unique.

In one embodiment, a LAG manager may import and export only a specification file. A specification may be importable if all of the identified applications are accessible by the LAG manager. Otherwise, a specification may be included in a package which contains the applications or missing type instances required, or provides additional information allowing the application or type instance to be located and retrieved for import. The package may be formatted as a multi-part mime entity. The first part may contain a package specification followed by application and instance parts. As an option, a part may contain a special URL that refers to an entity in another LAG manager with an indicator as to whether the entity is to be copied from the other LAG manager to the importing LAG manager or whether a reference to the remote entity is to be stored in the importing LAG manager.

In one embodiment, a LAG may include applications having output that is persistently stored. For example, API 142 may be used for storing and retrieving input and/or output data and invoking applications. By storing and retrieving input data that is persistently stored in a database, these applications may be stateful and may be associated with a system resource for performing stateful actions associated with the system resource.

In one embodiment, applications linked in a LAG may be associated with different programming languages. Thus, the subject matter provided herein may enhance the interoperability of applications created by different programming languages.

### Exemplary Applications

In a first exemplary application, an operator may desire to generate a LAG for locating compatible files for various applications that the operator uses. For example, the operator may desire to locate files for applications such as a word processor application, a spreadsheet application, a tax filing application, a drawing application, and an image editor application. Further, the operator may desire to present compatible files in a manner that makes it easier for the operator to locate the files that he or she wants an application to use. In order to create the LAG, the operator may invoke LAG manager 126 as a system resource through GUI 102.

The LAG may use a file search application for providing a file location function for the LAG. The file search application may include a command line script operable for searching from a specified starting point in system 100 for files that match one or more file name matching expressions supported by system 100. In one example, the file search application may receive input from “stdin”. The file search application may write its results to “stdout”. The LAG may be configured to receive the results from the application and place a copy of the results to an output data instance of the LAG which may be allocated for output for each instance of the file search application.

The operator may use a GUI specification language and suitable script for implementing a user interface to display a list of the output of the file search application. For example, the compatible files application may be generated by the XUL and the JavaScript software programs. The compatible files application may be operable to receive the output of the file search application from “stdin” or from an input set stored by LAG manager 126. Further, the compatible files application may be written such that if input is not received from “stdin”, the compatible files application may call the file search application for retrieving search results. In one example, the file search application may be enabled to output an application descriptor when invoked with the “-h” option.

By using LAG GUI 140 and LAG manager 126, the operator may enter data for generating a new LAG application. Further, the operator may enter in the location of the compatible files application and provide a name for the compatible files application. LAG manager 126 may retrieve and process an application descriptor for the identified compatible files application. As a result of processing the application descriptor, LAG manager 126 may determine the input and output data required for the compatible files application. For example, the required input data may be the output of the file search application. Further, for example, the required output data may be string data.

The generated LAG associates the file search application with an input which may contain a list of strings used for file name and attributes matching. Further, the LAG may associate the file search application with a string data for specifying a path to search. The output of the file search application may also be associated with an input data for the compatible files application. Each of these association properties may include an instance scope.

Further, the LAG may be configured to include lists of data instances for each various applications such as a word processing application, an image editor application, a drawing tool application, and a spreadsheet application. The values associated with these applications may be set to hold suitable matching search strings. Each list instance may be named. Further, the lists may be stored in database 128 in an instance table. A string data instance may be generated for each application for specifying the search location for compatible files.

The operator may generate an application (referred to herein as the StartAndPass application) that starts a specified application and passes all other input on as output and provides support for an -h option to produce the application descriptor. LAG manager 126 may associate the input that is passed with a URL data as input based on the application descriptor that identifies the application to be invoked. Instances of the URL data may be created for each application in use.

Further, the operator may create an input set including a URL data, a string for a search location, and a list for holding matching filters. Instances of the input set and their names may be created for each application using instance data previously placed in database 128. There may be one input set instance for each application. A LAG may be created by selecting the StartAndPass application, the file search application, compatible files application.

An instance of the LAG may be initiated by using each input set previously created. The operator may specify an icon, name, and description for each LAG instance. Further, the operator may specify that a shortcut is to be added to the desktop for each LAG instance.

In order to instantiate the LAG, an icon for the LAG instance may be selected. For example, an icon for the LAG associated with a word processing application may be displayed on GUI 102 and selected by the operator. The LAG instance may be started with a reference to the word processing application, a filter list for finding compatible files, and search locations being passed to the StartAndPass application instance for this active LAG instance. The StartAndPass application may invoke the word processing application and pass the remaining data to the next application in the active LAG instance (i.e., the file search application) by writing the string and list data to “stdout”. The file search application may be activated by LAG manager 126. Further, the StartAndPass application's “stdout” may be mapped to the file search application's “stdin”. The file search application may read its input from “stdin” and search the specified locations for files that it finds in its output list and to its “stdout”. LAG manager 126 may activate the compatible files application and map the file search application's “stdout” to the compatible files application's “stdin”. Since the file search application's “stdin” becomes input for the compatible file application, the file search application may obtain the list and display the list of compatible files in a GUI window along with a GUI window for the word processing application.

The operator may drag and drop files from GUI window containing the list of compatible files to the GUI window for the word processing application in order to work with them. The LAG may allow the operator to view compatible files in various categories and sort in different ways for the purpose of selecting one or more to edit.

In a second exemplary application, the operator that generated the LAG in the first exemplary application may export the associated LAG instances including their associated input sets, applications, input/output data, icons, and descriptions from LAG manager 126 and creates a package with the exported results and the applications and/or application references. The operator may make this package available on a website for free download. Another operator may download the package and import the package into her computer system's LAG manager 126.

A spreadsheet input set may be edited through LAG GUI 140 to change the spreadsheet application and change the filters to search for files compatible with the operator's preferred spreadsheet application. The operator may create new input sets using LAG GUI 140 and associate the input sets with the LAG. Further, the operator may create new LAG instances, add icons, and descriptions for new applications.

The operator may modify the file search application by adding a persistent list by using GUI 102. The list may serve as a persistent cache for the most recent search. Each active LAG instance may include a persistent state that may be stored between activations. The persistent state information may be passed via “stdin” or by command line activation and written to “stdout”. The file search application may be modified to immediately output the information in the cache, so the GUI immediately displays the last search results. The file search application may continue searching and provide updates as output when the search is completed.

The LAG may be modified to include a refresh icon that may be selected to activate the file search application for performing a new search in order to refresh the display of search results. The operator may select the icon for selectively searching for compatible files.

The operator may export the new versions of the LAG, package the new versions, and publish the packaged version to a download website.

Although an operator may utilize a GUI for creating and managing LAGs, systems in accordance with the subject matter described herein may also utilize APIs which allow software and/or hardware components to perform analogous steps.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for generating application processes by linking applications, the method comprising:
receiving, via a graphical user interface, identifiers for each of first and second applications;
determining output data for the first application from an application descriptor associated with the first application;
determining input data for the second application from an application descriptor associated with the second application;
displaying, via the graphical user interface, the output and input data;
receiving, via the graphical user interface, input indicating linking of the output data for the first application to the input data for the second application; and
creating a loadable instance operable to invoke the first application to generate a value for the output data and to invoke the second application with the generated value as the input data.

2. The method of claim 1 comprising determining information for invoking the first application from the application descriptor associated with the first application.

3. The method of claim 1 comprising determining information for invoking the second application from the application descriptor associated with the second application.

4. The method of claim 1 comprising storing the identifiers for the first and second applications, the output data for the first application, and the input data for the second application in a linked application graph (LAG) record.

5. The method of claim 4 comprising storing information for invoking the first and second applications in the LAG record.

6. The method of claim 4 comprising storing the linking input in the LAG record.

7. The method of claim 1 comprising:
invoking the first application;
receiving the value for the output data of the first application;
invoking the second application; and
inputting the value for the output data of the first application into the input data of the second application.

8. The method of claim 7 comprising prompting a user for a value for the output data of the first application when the output data value is not received from the first application.

9. The method of claim 8 comprising saving a value for the output data received from the user in response to the prompt.

10. The method of claim 8 comprising presenting selectable previously stored values for the output data received from the user in response to the prompt.

11. The method of claim 1 comprising:
determining output data of the first application that is compatible input data for the second application; and
controlling linking of the output data of the first application to input data of the second application based on the compatibility determination.

12. The method of claim 11 wherein controlling linking includes displaying only output data of the first application that is compatible input data for the second application.

13. The method of claim 11 wherein controlling linking includes displaying only input data of the second application that is compatible output data for the first application.

14. The method of claim 1 wherein creating a loadable instance includes creating an icon.

15. The method of claim 1 comprising receiving, via the graphical user interface, input for the first application.

16. The method of claim 1 wherein the first and second applications are associated with different programming languages.

17. The method of claim 1 wherein:
identifiers are received for each of a plurality of second applications;
input data is received for each of the plurality of second applications from an application descriptor associated with each respective second application;
input is received indicating a plurality of links of the output data for the first application to the input data for the second applications, wherein each link is associated with a different value for the output data for the first application; and
the loadable instance is operable to invoke the first application to generate the value for the output data and to invoke, with the generated value as the input data, a second application that is linked to the first application via the corresponding link associated with the value for the output data.

18. A system for generating application processes by linking applications, the system comprising:
a graphical user interface operable to:
receive identifiers for each of first and second applications;
display output data for the first application and input data for the second application; and
receive input indicating linking of the output data for the first application to the input data for the second application; and
a linked application graph (LAG) manager operable to:
determine the output data for the first application from an application descriptor associated with the first application;
determine the input data for the second application from an application descriptor associated with the second application; and
create a loadable instance operable to invoke the first application to generate a value for the output data and to invoke the second application with the generated value as the input data.

19. The system of claim 18 wherein the LAG manager is operable to determine information for invoking the first application from the application descriptor associated with the first application.

20. The system of claim 18 wherein the LAG manager is operable to determine information for invoking the second application from the application descriptor associated with the second application.

21. The system of claim 18 wherein the LAG manager is operable to store the identifiers for the first and second applications, the output data for the first application, and the input data for the second application in a LAG record.

22. The system of claim 21 wherein the LAG manager is operable to store information for invoking the first and second applications in the LAG record.

23. The system of claim 21 wherein the LAG manager is operable to store the linking input in the LAG record.

24. The system of claim 18 wherein the LAG manager is operable to:
invoke the first application;
receive the value for the output data of the first application;
invoke the second application; and
input the value for the output data of the first application into the input data of the second application.

25. The system of claim 24 wherein the graphical user interface is operable to prompt a user for a value for the output data of the first application when the output data value is not received from the first application.

26. The system, of claim 25 wherein the LAG manager is operable to save a value for the output data received from the user in response to the prompt.

27. The system of claim 25 wherein the LAG manager is operable to present selectable previously stored values for the output data received from the user in response to the prompt.

28. The system of claim 18 wherein the LAG manager is operable to:
determine output data of the first application that are compatible input data for the second application; and
control linking of the output data of the first application to input data of the second application based on the compatibility determination.

29. The system of claim 28 wherein the graphical user interface is operable to display only output data of the first application that are compatible input data for the second application.

30. The system of claim 28 wherein the graphical user interface is operable to display only input data of the second application that are compatible output data for the first application.

31. The system of claim 18 wherein the graphical user interface is operable to display an icon.

32. The system of claim 18 wherein the graphical user interface is operable to receive input for the first application.

33. The system of claim 18 wherein the first and second applications are associated with different programming languages.

34. The system of claim 18 wherein:
the graphical user interface is operable to:
receive identifiers for each of a plurality of second applications; and
receive input indicating a plurality of links of the output data for the first application to the input data for the second applications, wherein each link is associated with a different value for the output data for the first application;
the LAG is operable to:
determine input data for each of the second applications from an application descriptor associated with each respective second application; and
the loadable instance is operable to invoke the first application to generate the value for the output data and to invoke, with the generated value as the input data, a second application that is linked to the first application via the corresponding link associated with the value for the output data.

35. A system for generating application processes by linking applications, the system comprising:
means for receiving, via a graphical user interface, identifiers for each of first and second applications;
means for determining output data for the first application from an application descriptor associated with the first application;
means for determining input data for the second application from an application descriptor associated with the second application;
means for displaying, via the graphical user interface, the output and input data;
means for receiving, via the graphical user interface, input indicating linking of the output data for the first application to the input data for the second application; and
means for creating a loadable instance operable to invoke the first application to generate a value for the output data and to invoke the second application with the generated value as the input data.

36. A computer program product comprising computer executable instructions embodied in a computer readable medium for performing steps comprising:
receiving, via a graphical user interface, identifiers for each of first and second applications;
determining output data for the first application from an application descriptor associated with the first application;
determining input data for the second application from an application descriptor associated with the second application;
displaying, via the graphical user interface, the output and input data;
receiving, via the graphical user interface, input indicating linking of the output data for the first application to the input data for the second application; and
creating a loadable instance operable to invoke the first application to generate a value for the output data and to invoke the second application with the generated value as the input data.
